(19) United States
(12) Patent Application Publication
(10) Pub. No.: US 2024/0085512 A1
(43) Pub. Date: Mar. 14, 2024

(54) METHOD FOR POSITIONING MEASUREMENT REPORTING, APPARATUS AND SYSTEM

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 18/513,890

(22) Filed: Nov. 20, 2023

Related U.S. Application Data
(63) Continuation of application No. PCT/IB2022/055665, filed on Jun. 17, 2022.
(60) Provisional application No. 63/211,916, filed on Jun. 17, 2021.
(60) Provisional application No. 63/214,127, filed on Jun. 23, 2021.

(51) Int. Cl. G01S 5/00; G01S 5/02

(52) U.S. Cl. CPC G01S 5/0036; G01S 5/0218

(57) ABSTRACT

A method, apparatus and system for positioning measurement reporting are provided. The method includes sending, from a terminal device, a first message indicating a capability to support reporting information of line of sight (LOS) or non-line of sight (NLOS) of a path used in positioning measurement. The terminal device reports at least one positioning measurement result and the information of the LOS or NLOS of the path that corresponding to the at least one positioning measurement result.

### CROSS-REFERENCE TO RELATED APPLICATIONS

This application is a continuation of International Patent Application No. PCT/IB2022/055665, filed on Jun. 17, 2022, which claims the benefit of priorities to U.S. Provisional Patent Application No. 63/211,916, filed Jun. 17, 2021 and U.S. Provisional Patent Application No. 63/214,127, filed Jun. 23, 2021, both of which are hereby incorporated by reference in their entireties.

### BACKGROUND

Positioning technology is one of the core technologies of wireless communications systems and navigation systems. A 5G NR system supports positioning technology. In 3GPP, the following positioning solutions are specified: DL TDOA (downlink time difference of arrival) method, UL TDOA method, multi-RTT method, DL-AoD (downlink angle of departure) method, UL AoA (uplink angle of arrival) method, and E-CID (enhanced cell ID) method. In 3GPP NR, downlink positioning reference signal (PRS) was introduced to support downlink positioning measurement and SRS (sounding reference signal) for positioning was introduced to support uplink positioning measurement. Specially, the following measurements for positioning was supported in NR release 16: DL RSTD (reference signal time difference) measured from DL PRS, UL RTOA measured from SRS for positioning, UE Rx-Tx time difference, gNB Rx-Tx time difference, DL PRS RSRP (reference signal received power), UL SRS RSRP, and UL AoA.

The NR based positioning solutions involve the UE, the TRP (Transmission/Reception Point), and location server. The UE measures DL PRS resources sent from multiple different TRPs or transmits SRS resource for positioning. For determining the location of one UE, multiple TRPs are involved generally. Each TRP can transmit DL PRS to the UE or receive and measure SRS for positioning transmitted by the UE. The location server can be referenced to as a location management function (LMF).

An example of NR positioning based on DL measurement is as follows. An LMF (location management function) and TRP coordinate the DL PRS configurations; each TRP transmits DL PRS resource according to the configuration; the UE measures DL PRS resources transmitted from multiple TRPs and then measures the DL PRS RSRP and/or DL RSTD; the UE reports the positioning measurement results to the LMF; and at last, the LMF calculates the location of the UE based on the reported positioning measurement results.

One drawback of the current positioning measurement reporting is the LMF does not know if one positioning measurement is obtained from LOS (line f sight) transmission or NLOS (non-line-of-sight) transmission. Due to that, the LMF would have to assume all the reported measurement results are from LOS transmission. It is well known that the extra timing error caused by NLOS transmission can impair the performance of positioning significantly. But with the positioning measurement report in current method, the LMF is not able to reduce the negative impact of NLOS in positioning calculation.

Another drawback of the current positioning method is the positioning measurement based on PRS resource must be obtained from at least 4 PRS samples. That could increase the positioning latency and thus impair the performance of NR positioning. Another drawback is the UE can only measure PRS within measurement gap. The request and configuration of measurement gap generally causes large latency and thus it enlarges the latency of processing PRS and latency of NR positioning is enlarged. The consequence is the NR positioning cannot satisfy the service requirement in low-latency scenarios.

### SUMMARY

This application relates to the communications field, and more specifically, to a method for positioning measurement reporting, a terminal device and a system.

In a first aspect, there is provided a method for positioning measurement reporting. The method includes: sending, from a terminal device, a first message indicating a capability to support reporting information of line of sight (LOS) or non-line of sight (NLOS) of a path used in positioning measurement; and reporting, by the terminal device, at least one positioning measurement result and the information of the LOS or NLOS of the path corresponding to the at least one positioning measurement result.

In a second aspect, there is provided an apparatus. The apparatus includes a memory and a processor coupled to the memory and configured to perform a process including: sending, from a terminal device, a first message indicating a capability to support reporting information of line of sight (LOS) or non-line of sight (NLOS) of a path used in positioning measurement; and reporting, by the terminal device, at least one positioning measurement result and the information of the LOS or NLOS of the path corresponding to the at least one positioning measurement result.

In a third aspect, there is provided a system. The system includes a terminal device configured to perform a process including: sending, from the terminal device, a first message indicating a capability to support reporting information of line of sight (LOS) or non-line of sight (NLOS) of a path used in positioning measurement; and reporting, by the terminal device, at least one positioning measurement result and the information of the LOS or NLOS of the path corresponding to the at least one positioning measurement result.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram of a wireless communication system in accordance with one or more implementations of the present disclosure.

FIG. 2 is a schematic block diagram of a terminal device in accordance with one or more implementations of the present disclosure.

FIG. 3A is a flowchart of a method for positioning measurement reporting, in accordance with one or more implementations of the present disclosure.

FIG. 3B is a flowchart of a method for multipath positioning measurement and reporting, in accordance with one or more implementations of the present disclosure.

FIG. 4 is a flowchart of a method for measuring downlink positioning reference signals, in accordance with one or more implementations of the present disclosure.

### DETAILED DESCRIPTION

The present disclosure is directed to systems and methods for multipath positioning measurement and reporting. More particularly, the present systems and methods can support reporting accurate positioning measurement results to the location server so that the location server can minimize the negative impact of NLOS on the performance of location calculation.

In some embodiments, the present systems and methods can provide a solution to resolve the issue of positioning measurement reporting in the scenarios where the link between TRP and UE is not line-of-sight. The UE can report its capability to support indicating whether one positioning measurement is obtained from line-of-sight signal or non-line-of-sight signal. For a DL TDOA measurement, the UE can report related information of LOS or NLOS. For a DL AoD measurement, the UE can report related information of LOS or NLOS. For UE Rx-Tx time difference measurement, the UE can report related information of LOS or NLOS. For a UL AoA measurement, the TRP can report related information of LOS or NLOS. For a gNB Rx-Tx time difference measurement, the TRP can report related information of LOS or NLOS. For a gNB RTOA measurement result, the TRP can report related information of LOS or NLOS. For a SRS RSRP measurement results, the TRP can report related information of LOS or NLOS.

In some embodiments, the present systems and methods can provide solutions for the issue of measuring PRS resource to obtain corresponding positioning measurement results. A location server can indicate the UE to obtain positioning measurement results with given number of measurement samples. The UE reports the number of measurement samples used for a reported positioning measurement. The UE can report the UE capability of supported number of measurement samples for positioning measurement. The location server can indicate a UE to measure the PRS resource without measurement gap. The present systems and methods can support flexible positioning measurement with various number of samples and thus the system can choose the best balance between positioning measurement accuracy and latency.

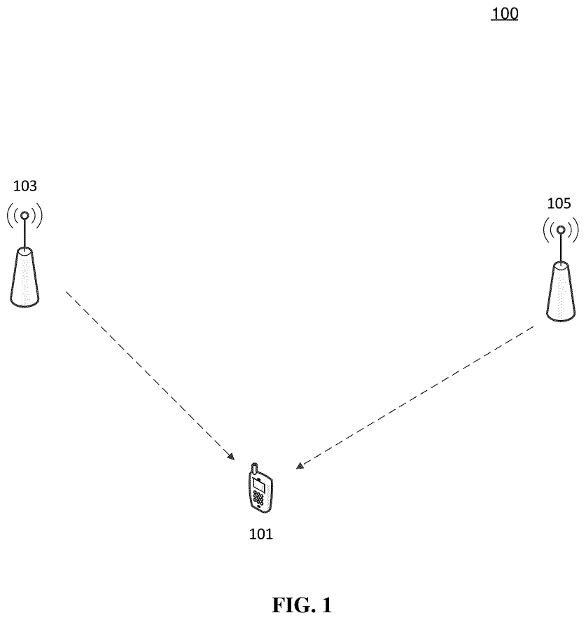

FIG. 1 is a schematic diagram of a wireless communication system 100 in accordance with one or more implementations of the present disclosure. As shown in FIG. 1, the wireless communications system 100 can be a multi-TRP transmission system that includes one or more TRPs (e.g., a TRP 103 and a TRP 105) that can constitute one or more network nodes/devices (or base stations). Examples of the network node/device include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network node/device can include a relay station, an access point, an in-vehicle device, a wearable device, and the like. The network node can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as an NR system or network.

In FIG. 1, the wireless communications system 100 also includes a terminal device 101. The terminal device 101 can be an end-user device configured to facilitate wireless communication. The terminal device 101 can be configured to wirelessly connect to the network node/device (via, e.g., via a wireless channel) according to one or more corresponding communication protocols/standards. The terminal device 101 may be mobile or fixed. The terminal device 101 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 101 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 1 illustrates only two network nodes/devices (i.e., TRPs 103, 105) and one terminal device 101 in the wireless communications system 100. However, in some instances, the wireless communications system 100 can include additional network nodes/devices and/or terminal devices.

In some embodiments, the wireless communications system 100 can provide a solution to resolve the issue of positioning measurement reporting in the scenarios where the link between TRP (e.g., a TRP 103 and a TRP 105) and UE 101 is not line-of-sight. The UE 101 can report its capability to support indicating whether one positioning measurement is obtained from line-of-sight signal or non-line-of-sight signal. For a DL TDOA measurement, the UE 101 can report related information of LOS or NLOS. For a DL AoD measurement, the UE 101 can report related information of LOS or NLOS. For UE Rx-Tx time difference measurement, the UE 101 can report related information of LOS or NLOS. For a UL AoA measurement, the TRP can report related information of LOS or NLOS. For a gNB Rx-Tx time difference measurement, the TRP (e.g., a TRP 103 and a TRP 105) can report related information of LOS or NLOS. For a gNB RTOA measurement result, the TRP can report related information of LOS or NLOS. For a SRS RSRP measurement results, the TRP can report related information of LOS or NLOS. The wireless communications system 100 can support reporting accurate positioning measurement results to the Location server so that the location server can minimize the negative impact of NLOS on the performance of location calculation.

The wireless communications system 100 can provide solutions for the issue of measuring PRS resource to obtain corresponding positioning measurement results. Location server can indicate the UE 101 to obtain positioning measurement results with given number of measurement samples. The UE 101 reports the number of measurement samples used for a reported positioning measurement. The UE 101 can report the UE capability of supported number of measurement samples for positioning measurement. The location server can indicate a UE to measure the PRS resource without measurement gap. The wireless communications system 100 can support flexible positioning measurement with various number of samples and thus the system can choose the best balance between positioning measurement accuracy and latency.

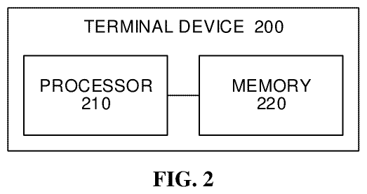

FIG. 2 is a schematic block diagram of a terminal device in accordance with one or more implementations of the present disclosure. FIG. 2 is a schematic block diagram of a terminal device 200 (e.g., an example of the terminal device 101 of FIG. 1) in accordance with one or more implementations of the present disclosure. As shown in FIG. 2, the terminal device 200 includes a processing unit 210 (e.g., a DSP, a CPU, a GPU, etc.) and a memory 220. The processing unit 210 can be configured to implement instructions that correspond to the methods discussed herein and/or other aspects of the implementations described above. The processing unit 210 may also be coupled to a memory 220.

It should be understood that the processor in the implementations of this technology may be an integrated circuit chip and has a signal processing capability. During implementation, the steps in the foregoing method may be implemented by using an integrated logic circuit of hardware in the processor or an instruction in the form of software. The processor may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor may be a microprocessor, or the processor may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory, and the processor reads information in the memory and completes the steps in the foregoing methods in combination with the hardware thereof.

It may be understood that the memory 220 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type.

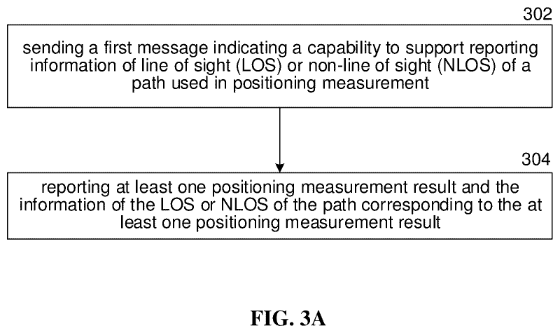

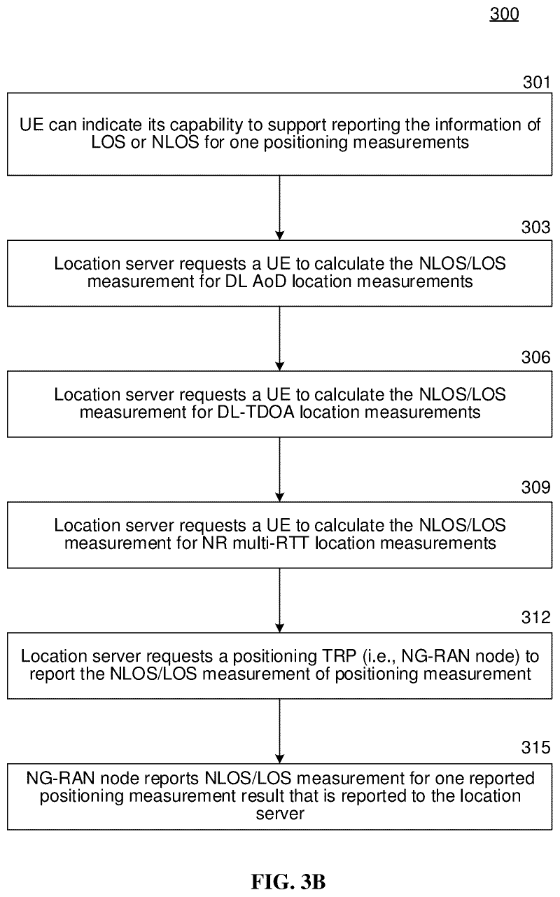

FIG. 3A is a flowchart of a method for positioning measurement reporting, in accordance with one or more implementations of the present disclosure.

At block 302, a terminal device sends a first message indicating a capability to support reporting information of line of sight (LOS) or non-line of sight (NLOS) of a path used in positioning measurement.

At block 304, the terminal device reports at least one positioning measurement result and the information of the LOS or NLOS of the path corresponding to the at least one positioning measurement result.

FIG. 3B is a flowchart of a method 300 for multipath positioning measurement and reporting, in accordance with one or more implementations of the present disclosure. The method 300 can be implemented by a wireless communications system (e.g., the wireless communications system 100) that includes a terminal device (e.g., the terminal device 101) and a network node/device or gNB (e.g., the TRPs or other suitable network node/device described herein). The method 300 can support reporting accurate positioning measurement results to the location server so that the location server can minimize the negative impact of NLOS on the performance of location calculation.

In one embodiment, a UE can indicate its capability to support reporting the information of LOS or NLOS of the path used in positioning measurement. The location server (e.g., LMF (location management function)) can configure the UE to report positioning measurement results and configure the UE to report the information of LOS or NLOS of the path used to obtain one reported positioning measurement result. According to the configuration provided by the location server, the UE can report one positioning measurement result and the UE can also report the information of LOS or NLOS of path that is related with the reported positioning measurement results. The location server can configure one TRP to report uplink positioning measurement results and also configure the TRP to report information of LOS or NLOS of the path used to obtain the reported positioning measurement results. According to the configuration (or request) provided by the location server, the TRP can report one uplink positioning measurement results and the TRP can also report the information of LOS or NLOS of the path that is related with the reported uplink positioning measurement results.

For each positioning measurement results, the information of LOS or NLOS of the path can be one or more of the following information: one indicator to indicate whether the corresponding positioning measurement result is obtained from a LOS path or NLOS path; one indicator to indicate the confidence level of that the path used to obtain the corresponding positioning measurement results is a LOS path. For example, the value of this indicator can be from 0 to 100; one indicator to indicate the confidence level of that the path used to obtain the corresponding positioning measurement results is a NLOS path. For example, the value of this indicator can be from 0 to 100; one indicator to indicate the measure of line of sight of the path used to obtain the corresponding positioning measurement result, for example this indicator can be the value of Rician K-factor.

The UE can be configured to report the indicator of LOS or NLOS for one or more of the following positioning measurement result: DL-TDOA positioning. The positioning measurement can be DL RSTD measurement; DL-AoD positioning, the positioning measurement can be DL PRS RSRP measurement; and/or multi-RTT positioning, the positioning measurement can be UE Rx-Tx time difference.

The TRP can be configured to report the indicator of LOS or NLOS for one or more of the following positioning measurement results: the measurement of UL angle of arrival; the measurement of UL SRS-RSRP; the measurement of UL RTOA; and/or the measurement of gNB Rx-Tx time difference.

At block 301, a UE can indicate its capability to support reporting the information of LOS or NLOS for one positioning measurements. In one example, the UE can indicate its capability to support reporting whether one positioning measurement is obtained from signal path that is LOS or NLOS. In one example, the UE can indicate its capability to support reporting the indicator of LOS (or NLOS) condition of path used to obtain one positioning measurement. In one example, the UE can indicate its capability to support reporting the LOS measurement (for example Rician K-factor) related with the positioning measurement.

In one example, the UE can indicate its capability to support NR DL-TDOA and provides its NR DL-TDOA positioning capabilities to the location server. In the UE capability report, the UE can report its capability to support reporting the information of LOS or NLOS measurement for the NR DL TDOA positioning. An example of the IE NR-DL-TDOA-ProvideCapabilities is given as follows:

| - | NR-DL-TDOA-ProvideCapabilities-r16 ::= SEQUENCE { | | |
|---|---|---|---|
| - | nr-DL-TDOA-Mode-r16 | PositioningModes, | |
| - | nr-DL-TDOA-PRS-Capability-r16 | NR-DL-PRS-ResourcesCapability-r16, | |
| - | nr-DL-TDOA-MeasurementCapability-r16 NR-DL-TDOA-MeasurementCapability- | | |
| | r16, | | |
| - | nr-DL-PRS-QCL-ProcessingCapability-r16NR-DL-PRS-QCL-ProcessingCapability- | | |
| | r16, | | |
| - | nr-DL-PRS-ProcessingCapability-r16 | NR-DL-PRS-ProcessingCapability-r16, | |
| - | additionalPathsReport-r16 | ENUMERATED { supported } | |
| | OPTIONAL, | | |
| - | periodicalReporting-r16 | PositioningModes | |
| | OPTIONAL, | | |
| - | nlosReporting | NR-DL-NLOS-ReportCapability | OPTIONAL |

| | |
|---|---|
| - | ... |
| - | } |

where parameter nlosReporting is the field used by the UE to indicate its capability to support LOS or NLOS measurement for DL-TDOA positioning.

In one example, the UE can indicate its capability to support NR DL-AoD and provides its NR DL-AoD positioning capabilities to the location server. In the UE capability report, the UE can report its capability to support reporting the information of LOS or NLOS measurement for the NR DL AoD positioning. An example of the IE NR-DL-AoD-ProvideCapabilities is given as follows:

| - | NR-DL-AoD-ProvideCapabilities-r16 ::= SEQUENCE { | | |
|---|---|---|---|
| - | nr-DL-AoD-Mode-r16 | PositioningModes, | |
| - | nr-DL-AoD-PRS-Capability-r16 | NR-DL-PRS-ResourcesCapability-r16, | |
| - | nr-DL-AoD-MeasurementCapability-r16 | NR-DL-AoD-MeasurementCapability- | |
| | r16, | | |
| - | nr-DL-PRS-QCL-ProcessingCapability-r16NR-DL-PRS-QCL-ProcessingCapability- | | |
| | r16, | | |
| - | nr-DL-PRS-ProcessingCapability-r16 | NR-DL-PRS-ProcessingCapability-r16, | |
| - | periodicalReporting-r16 | PositioningModes | |
| | OPTIONAL, | | |
| - | nlosReporting | NR-DL-NLOS-ReportCapability | OPTIONAL |

| | |
|---|---|
| - | ... |
| - | } |

where parameter nlosReporting is the field used by the UE to indicate its capability to support LOS or NLOS measurement for DL-AoD positioning.

In one example, the UE can indicate its capability to support NR multi-RTT and provides its NR multi-RTT positioning capabilities to the location server. In the UE capability report, the UE can report its capability to support reporting the information of LOS or NLOS measurement for the NR multi-RTT positioning. An example of the IE NR-Multi-RTT-ProvideCapabilities is given as follows:

| - | NR-Multi-RTT-ProvideCapabilities-r16 ::= SEQUENCE { | | |
|---|---|---|---|
| - | nr-Multi-RTT-PRS-Capability-r16 | NR-DL-PRS-ResourcesCapability-r16, | |
| - | nr-Multi-RTT-MeasurementCapability-r16 NR-Multi-RTT-MeasurementCapability- | | |
| | r16, | | |
| - | nr-DL-PRS-QCL-ProcessingCapability-r16NR-DL-PRS-QCL-ProcessingCapability- | | |
| | r16, | | |
| - | nr-DL-PRS-ProcessingCapability-r16 | NR-DL-PRS-ProcessingCapability-r16, | |
| - | nr-UL-SRS-Capability-r16 | NR-UL-SRS-Capability-r16, | |
| - | additionalPathsReport-r16 | ENUMERATED { supported } | |
| | OPTIONAL, | | |
| - | periodicalReporting-r16 | ENUMERATED { supported } | |
| | OPTIONAL, | | |
| - | nlosReporting | NR-DL-NLOS-ReportCapability | OPTIONAL |

| | |
|---|---|
| - | ... |
| - | } |

where parameter nlosReporting is the field used by the UE to indicate its capability to support LOS or NLOS measurement for multi-RTT positioning.

At block 303, the location server can request a UE to calculate the NLOS/LOS measurement for DL AoD location measurements. Upon the requesting from the location server, the UE can calculate the NLOS/LOS measurement for DL AoD location measurement and then report the NLOS/LOS measurement for each reported DL AoD location measurement result.

In one example, the location server can configure the UE to calculate the NLOS/LOS measurement for DL AoD location measurement through the assistance data for NR DL-AoD. The location server can provide that configuration in the IE NR-DL-AoD-ProvideAssistanceData:

| - | NR-DL-AoD-ProvideAssistanceData-r16 :: = SEQUENCE { | |
|---|---|---|
| - | nr-DL-PRS-AssistanceData-r16 | NR-DL-PRS-AssistanceData-r16 |
| | OPTIONAL, -- Need ON | |
| - | nr-SelectedDL-PRS-IndexList-r16 | NR-SelectedDL-PRS-IndexList-r16 |
| | OPTIONAL, -- Need ON | |
| - | nr-PositionCalculationAssistance-r16 | |
| - | | NR-PositionCalculationAssistance-r16 |
| - | | OPTIONAL, - |
| | - Cond UEB | |
| - | nr-DL-AoD-Error-r16 | NR-DL-AoD-Error-r16 |
| | OPTIONAL, -- Need ON | |
| - | nr-DL-AoD-LOS-measurement | NR-DL-LOS-Measurement |

| | |
|---|---|
| | OPTIONAL, |
| - | ... |
| - | } |

where the field nr-DL-AoD-LOS-measurement is used to specify the UE to report NLOS/LOS for DL AoD measurement.

In one example, the location server can request the UE to report LOS/NLOS measurement for DL AoD measurement through the IE NR-DL-AoD-RequestLocationInformation:

| - | NR-DL-AoD-RequestLocationInformation-r16 ::= SEQUENCE { | |
|---|---|---|
| - | nr-AssistanceAvailability-r16 | BOOLEAN, |
| - | nr-DL-AoD-ReportConfig-r16 | NR-DL-AoD-ReportConfig-r16, |
| - | nr-DL-AoD-LOS-measurement | NR-DL-LOS-Measurement |

| | |
|---|---|
| | OPTIONAL, |
| - | ... |
| - | } |

In another example, the location server can request the UE to report LOS/NLOS measurement for DL AoD measurement through the IE NR-DL-AoD-ReportConfig:

NR-DL-AoD-ReportConfig-r16 ::= SEQUENCE {

| | |
|---|---|
| maxDL-PRS-RSRP-MeasurementsPerTRP-r16 | INTEGER (1..8) |

OPTIONAL,

| | | |
|---|---|---|
| nr-DL-AoD-LOS-measurement | NR-DL-LOS-Measurement | OPTIONAL |

...
}

In one example, a UE can report the NLOS/LOS measurement for each NR AoD measurements to the location server. For example, the UE can report the NLOS/LOS measurement for each AoD measurement in IE NR-DL-AoD-SignalMeasurementInformation as follows:

| - | NR-DL-AoD-SignalMeasurementInformation-r16 ::= SEQUENCE { | |
|---|---|---|
| - | nr-DL-AoD-MeasList-r16 | NR-DL-AoD-MeasList-r16, |

| | |
|---|---|
| - | ... |
| - | } |

-

| | |
|---|---|
| - | NR-DL-AoD-MeasList-r16 ::= SEQUENCE (SIZE(1..nrMaxTRPs-r16)) OF NR- |
| | DL-AoD-MeasElement-r16 |

-

| - | NR-DL-AoD-MeasElement-r16 ::= SEQUENCE { | |
|---|---|---|
| - | dl-PRS-ID-r16 | INTEGER (0..255), |
| - | nr-PhysCellID-r16 | NR-PhysCellID-r16 |
| | OPTIONAL, | |
| - | nr-CellGlobalID-r16 | NCGI-r15 |
| | OPTIONAL, | |
| - | nr-ARFCN-r16 | ARFCN-ValueNR-r15 |
| | OPTIONAL, | |
| - | nr-DL-PRS-ResourceID-r16 | NR-DL-PRS-ResourceID-r16 |
| | OPTIONAL, | |
| - | nr-DL-PRS-ResourceSetID-r16 | NR-DL-PRS-ResourceSetID-r16 |
| | OPTIONAL, | |
| - | nr-TimeStamp-r16 | NR-TimeStamp-r16, |
| - | nr-DL-PRS-RSRP-Result-r16 | INTEGER (0..126), |
| - | nr-DL-PRS-RxBeamIndex-r16 | INTEGER (1..8) |

OPTIONAL, -- Cond SameRx

Alt1:

| | | |
|---|---|---|
| nr-DL-PRS-LOS-indicator | INTEGER(0,1) | OPTIONAL |

Alt2:

| | | |
|---|---|---|
| nr-DL-PRS-LOS-confidence | INTEGER(0...100), | OPTIONAL |

Alt3:

| | | |
|---|---|---|
| nr-DL-PRS-kFactor | INTEGER(0...K) | OPTIONAL |

| - | nr-DL-AoD-AdditionalMeasurements-r16 | |
|---|---|---|
| - | | NR-DL-AoD-AdditionalMeasurements-r16 |

| | |
|---|---|
| | OPTIONAL, |
| - | ... |
| - | } |

-

| | |
|---|---|
| - | NR-DL-AoD-AdditionalMeasurements-r16 ::= SEQUENCE (SIZE (1..7)) OF |

| | |
|---|---|
| - | NR-DL-AoD- |

AdditionalMeasurementElement-r16

-

| - | NR-DL-AoD-AdditionalMeasurementElement-r16 ::= SEQUENCE { | | |
|---|---|---|---|
| - | nr-DL-PRS-ResourceID-r16 | NR-DL-PRS-ResourceID-r16 | |
| | OPTIONAL, | | |
| - | nr-DL-PRS-ResourceSetID-r16 | NR-DL-PRS-ResourceSetID-r16 | |
| | OPTIONAL, | | |
| - | nr-TimeStamp-r16 | NR-TimeStamp-r16, | |
| - | nr-DL-PRS-RSRP-ResultDiff-r16 | INTEGER (0..30), | |
| - | nr-DL-PRS-RxBeamIndex-r16 | INTEGER (1..8) | |
| | OPTIONAL, -- Cond SameRx | | |
| - | Alt1: | | |
| - | nr-DL-PRS-LOS-indicator | INTEGER(0,1) | OPTIONAL |
| - | Alt2: | | |
| - | nr-DL-PRS-LOS-confidence | INTEGER(0...100), | OPTIONAL |
| - | Alt3: | | |
| - | nr-DL-PRS-kFactor | INTEGER(0...K) | OPTIONAL |

-

| | |
|---|---|
| - | ... |
| - | } |

At block 306, the location server can request a UE to calculate the NLOS/LOS measurement for DL-TDOA location measurements. Upon the requesting from the location server, the UE can calculate the NLOS/LOS measurement for DL-TDOA location measurement and then report the NLOS/LOS measurement for each reported DL-TDOA location measurement result.

In one example, the location server can configure the UE to calculate the NLOS/LOS measurement for DL-TDOA location measurement through the assistance data for NR DL-DTOA. The location server can provide that configuration in the IE NR-DL-TDOA-ProvideAssistanceData as follows:

| - | NR-DL-TDOA-ProvideAssistanceData-r16 ::= SEQUENCE { | |
|---|---|---|
| - | nr-DL-PRS-AssistanceData-r16 | NR-DL-PRS-AssistanceData-r16 |
| | OPTIONAL, -- Need ON | |
| - | nr-SelectedDL-PRS-IndexList-r16 | NR-SelectedDL-PRS-IndexList-r16 |
| | OPTIONAL, -- Need ON | |
| - | nr-PositionCalculationAssistance-r16 | |
| - | | NR-PositionCalculationAssistance-r16 |
| - | | OPTIONAL, - |
| | - Cond UEB | |
| - | nr-DL-TDOA-Error-r16 | NR-DL-TDOA-Error-r16 |
| | OPTIONAL, -- Need ON | |
| - | nr-DL-TDOA-LOS-measurement | NR-DL-TDOA-Measurement |

| | |
|---|---|
| | OPTIONAL, |
| - | ... |
| - | } |

where the field nr-DL-TDOA-LOS-measurement is used to specify the UE to report NLOS/LOS for DL-TDOA measurement.

In one example, the location server can request the UE to report LOS/NLOS measurement for DL-TDOA measurement through the IE NR-DL-TDOA-RequestLocationInformation as follows:

| - | NR-DL-TDOA-RequestLocationInformation-r16 ::= SEQUENCE { | |
|---|---|---|
| - | nr-DL-PRS-RstdMeasurementInfoRequest-r16 ENUMERATED { true } | |
| | OPTIONAL,-- Need ON | |
| - | nr-RequestedMeasurements-r16 | BIT STRING { prsrsrpReq (0) } |
| | (SIZE(1..8)), | |
| - | nr-AssistanceAvailability-r16 | BOOLEAN, |
| - | nr-DL-TDOA-ReportConfig-r16 | NR-DL-TDOA-ReportConfig-r16 |
| | OPTIONAL, -- Need ON | |
| - | additionalPaths-r16 | ENUMERATED { requested } |
| | OPTIONAL, -- Need ON | |
| - | nr-DL-TDOA-LOS-measurement | NR-DL-TDOA-Measurement |

| | |
|---|---|
| | OPTIONAL, |
| - | ... |
| - | } |

In another example, the location server can request the UE to report LOS/NLOS measurement for DL-TDOA measurement through the IE NR-DL-TDOA-ReportConfig as follows:

| - | NR-DL-TDOA-ReportConfig-r16 ::= SEQUENCE { | |
|---|---|---|
| - | maxDL-PRS-RSTD-MeasurementsPerTRPPair-r16 INTEGER (1..4) | |
| | OPTIONAL, -- Need ON | |
| - | timing | INTEGER (0..5) |
| | ReportingGranularityFactor-r16 | |
| | OPTIONAL, -- Need ON | |
| - | nr-DL-TDOA-LOS-measurement | NR-DL-TDOA-Measurement |

| | |
|---|---|
| | OPTIONAL, |
| - | ... |
| - | } |

In one example, a UE can report the NLOS/LOS measurement for each NR DL-TDOA measurements to the location server. For example, the UE can report the NLOS/LOS measurement for each DL-DTOA measurement in IE NR-DL-TDOA-SignalMeasurementInformation as follows:

| - | NR-DL-TDOA-SignalMeasurementInformation-r16 ::= SEQUENCE { | |
|---|---|---|
| - | dl-PRS-ReferenceInfo-r16 | DL-PRS-ID-Info-r16, |

Alt1:

| | | |
|---|---|---|
| nr-DL-PRS-LOS-indicator | INTEGER(0,1) | OPTIONAL |

Alt2:

| | | |
|---|---|---|
| nr-DL-PRS-LOS-confidence | INTEGER(0...100), | OPTIONAL |

Alt3:

| | | |
|---|---|---|
| - | nr-DL-PRS-kFactor | INTEGER(0...K) |
| - | nr-DL-TDOA-MeasList-r16 | NR-DL-TDOA-MeasList-r16, |

| | |
|---|---|
| - | ... |
| - | } |

-

| | |
|---|---|
| - | NR-DL-TDOA-MeasList-r16 ::= SEQUENCE (SIZE(1..nrMaxTRPs-r16)) OF NR- |
| | DL-TDOA-MeasElement-r16 |

-

| - | NR-DL-TDOA-MeasElement-r16 ::= SEQUENCE { | | |
|---|---|---|---|
| - | dl-PRS-ID-r16 | INTEGER (0..255), | |
| - | nr-PhysCellID-r16 | NR-PhysCellID-r16 | |
| | OPTIONAL, | | |
| - | nr-CellGlobalID-r16 | NCGI-r15 | |
| | OPTIONAL, | | |
| - | nr-ARFCN-r16 | ARFCN-ValueNR-r15 | |
| | OPTIONAL, | | |
| - | nr-DL-PRS-ResourceID-r16 | NR-DL-PRS-ResourceID-r16 | |
| | OPTIONAL, | | |
| - | nr-DL-PRS-ResourceSetID-r16 | NR-DL-PRS-ResourceSetID-r16 | |
| | OPTIONAL, | | |
| - | nr-TimeStamp-r16 | NR-TimeStamp-r16, | |
| - | nr-RSTD-r16 | CHOICE { | |
| - | k0-r16 | INTEGER (0..1970049), | |
| - | k1-r16 | INTEGER (0..985025), | |
| - | k2-r16 | INTEGER (0..492513), | |
| - | k3-r16 | INTEGER (0..246257), | |
| - | k4-r16 | INTEGER (0..123129), | |
| - | k5-r16 | INTEGER (0..61565), | |
| - | ... | | |
| - | }, | | |
| - | Alt1: | | |
| - | nr-DL-PRS-LOS-indicator | INTEGER(0,1) | OPTIONAL |
| - | Alt2: | | |
| - | nr-DL-PRS-LOS-confidence | INTEGER(0...100), | OPTIONAL |

| - | Alt3: | |
|---|---|---|
| - | nr-DL-PRS-kFactor | INTEGER(0...K) |
| - | nr-AdditionalPathList-r16 | NR-AdditionalPathList-r16 |
| | OPTIONAL, | |
| - | nr-TimingQuality-r16 | NR-TimingQuality-r16, |
| - | nr-DL-PRS-RSRP-Result-r16 | INTEGER (0..126) |

| | |
|---|---|
| | OPTIONAL, |
| - | nr-DL-TDOA-AdditionalMeasurements-r16 |

| | |
|---|---|
| - | NR-DL-TDOA-AdditionalMeasurements-r16 |

| | |
|---|---|
| | OPTIONAL, |
| - | ... |
| - | } |

-

| - | NR-DL-TDOA-AdditionalMeasurements-r16 ::= SEQUENCE (SIZE (1..3)) OF | |
|---|---|---|
| - | | NR-DL-TDOA- |
| | AdditionalMeasurementElement-r16 | |
| - | NR-DL-TDOA-AdditionalMeasurementElement-r16 ::= SEQUENCE { | |
| - | nr-DL-PRS-ResourceID-r16 | NR-DL-PRS-ResourceID-r16 |
| | OPTIONAL, | |
| - | nr-DL-PRS-ResourceSetID-r16 | NR-DL-PRS-ResourceSetID-r16 |
| | OPTIONAL, | |
| - | nr-TimeStamp-r16 | NR-TimeStamp-r16, |
| - | nr-RSTD-ResultDiff-r16 | CHOICE { |
| - | k0-r16 | INTEGER (0..8191), |
| - | k1-r16 | INTEGER (0..4095), |
| - | k2-r16 | INTEGER (0..2047), |
| - | k3-r16 | INTEGER (0..1023), |
| - | k4-r16 | INTEGER (0..511), |
| - | k5-r16 | INTEGER (0..255), |

| | |
|---|---|
| - | ... |
| - | }, |

Alt1:

| | | |
|---|---|---|
| nr-DL-PRS-LOS-indicator | INTEGER(0,1) | OPTIONAL |

Alt2:

| | | |
|---|---|---|
| nr-DL-PRS-LOS-confidence | INTEGER(0...100), | OPTIONAL |

Alt3:

| - | nr-DL-PRS-kFactor | INTEGER(0...K) |
|---|---|---|
| - | nr-Timing Quality-r16 | NR-TimingQuality-r16, |
| - | nr-DL-PRS-RSRP-ResultDiff-r16 | INTEGER (0..61) |
| | OPTIONAL, | |
| - | nr-AdditionalPathList-r16 | NR-AdditionalPathList-r16 |

| | |
|---|---|
| | OPTIONAL, |
| - | ... |
| - | } |

At block 309, the location server can request a UE to calculate the NLOS/LOS measurement for NR multi-RTT location measurements. Upon the requesting from the location server, the UE can calculate the NLOS/LOS measurement for NR multi-RTT location measurement and then report the NLOS/LOS measurement for each reported NR multi-RTT location measurement result.

In one example, the location server can configure the UE to calculate the NLOS/LOS measurement for NR multi-RTT location measurement through the assistance data for NR multi-RTT. The location server can provide that configuration in the IE NR-Multi-RTT-ProvideAssistanceData as follows:

| - | NR-Multi-RTT-ProvideAssistanceData-r16 ::= SEQUENCE { | |
|---|---|---|
| - | nr-DL-PRS-AssistanceData-r16 | NR-DL-PRS-AssistanceData-r16 |
| | OPTIONAL, -- Need ON | |
| - | nr-SelectedDL-PRS-IndexList-r16 | NR-SelectedDL-PRS-IndexList-r16 |
| | OPTIONAL, -- Need ON | |
| - | nr-Multi-RTT-Error-r16 | NR-Multi-RTT-Error-r16 |
| | OPTIONAL, -- Need ON | |
| - | nr-Multi-RTT-LOS-measurement | NR-Multi-RTT-LOS-Measurement |

OPTIONAL,

-

| | |
|---|---|
| - | ... |
| - | } |

where the field nr-Multi-RTT-LOS-measurement is used to specify the UE to report NLOS/LOS for NR multi-RTT measurement.

In one example, the location server can request the UE to report LOS/NLOS measurement for NR multi-RTT measurement through the IE NR-Multi-RTT-RequestLocationInformation as follows:

| - | NR-Multi-RTT-RequestLocationInformation-r16 :: = SEQUENCE { | |
|---|---|---|
| - | nr-UE-RxTxTimeDiffMeasurementInfoRequest-r16 | |
| - | | ENUMERATED { true } |
| | OPTIONAL, -- Need ON | |
| - | nr-RequestedMeasurements-r16 | BIT STRING { prsrsrpReq(0)} (SIZE(1..8)), |
| - | nr-AssistanceAvailability-r16 | BOOLEAN, |
| - | nr-Multi-RTT-ReportConfig-r16 | NR-Multi-RTT-ReportConfig-r16, |
| - | additionalPaths-r16 | ENUMERATED { requested } |
| | OPTIONAL, -- Need ON | |
| - | nr-Multi-RTT-LOS-measurement | NR-Multi-RTT-LOS-Measurement |

| | |
|---|---|
| | OPTIONAL, |
| - | ... |
| - | } |

In another example, the location server can request the UE to report LOS/NLOS measurement for NR multi-RTT measurement through the IE NR-Multi-RTT-ReportConfig as follows:

NR-Multi-RTT-ReportConfig-r16 ::= SEQUENCE {

| | |
|---|---|
| maxDL-PRS-RxTxTimeDiffMeasPerTRP-r16 | INTEGER (1..4) |

OPTIONAL, -- Need ON

| | | |
|---|---|---|
| timingReportingGranularityFactor-r16 | INTEGER (0..5) | OPTIONAL-- |

Need ON

| | |
|---|---|
| - nr-Multi-RTT-LOS-measurement | NR-Multi-RTT-LOS-Measurement |

OPTIONAL,
}

In one example, a UE can report the NLOS/LOS measurement for each NR multi-RTT measurements to the location server. For example, the UE can report the NLOS/LOS measurement for each multi-RTT measurement in IE NR-Multi-RTT-SignalMeasurementInformation as follows:

| - | NR-Multi-RTT-SignalMeasurementInformation-r16 ::= SEQUENCE { | |
|---|---|---|
| - | nr-Multi-RTT-MeasList-r16 | NR-Multi-RTT-MeasList-r16, |
| - | nr-NTA-Offset-r16 | ENUMERATED { nTA1, nTA2, nTA3, nTA4, ... } |

| | |
|---|---|
| | OPTIONAL, |
| - | ... |
| - | } |

-

| | |
|---|---|
| - | NR-Multi-RTT-MeasList-r16 ::= SEQUENCE (SIZE(1..nrMaxTRPs-r16)) OF NR- |
| | Multi-RTT-MeasElement-r16 |

-

| - | NR-Multi-RTT-MeasElement-r16 ::= SEQUENCE { | | |
|---|---|---|---|
| - | dl-PRS-ID-r16 | INTEGER (0..255), | |
| - | nr-PhysCellID-r16 | NR-PhysCellID-r16 | |
| | OPTIONAL, | | |
| - | nr-CellGlobalID-r16 | NCGI-r15 | |
| | OPTIONAL, | | |
| - | nr-ARFCN-r16 | ARFCN-ValueNR-r15 | |
| | OPTIONAL, | | |
| - | nr-DL-PRS-ResourceID-r16 | NR-DL-PRS-ResourceID-r16 | |
| | OPTIONAL, | | |
| - | nr-DL-PRS-ResourceSetID-r16 | NR-DL-PRS-ResourceSetID-r16 | |
| | OPTIONAL, | | |
| - | nr-UE-RxTxTimeDiff-r16 | CHOICE { | |
| - | k0-r16 | INTEGER (0..1970049), | |
| - | k1-r16 | INTEGER (0..985025), | |
| - | k2-r16 | INTEGER (0..492513), | |
| - | k3-r16 | INTEGER (0..246257), | |
| - | k4-r16 | INTEGER (0..123129), | |
| - | k5-r16 | INTEGER (0..61565), | |
| - | ... | | |
| - | }, | | |
| - | Alt1: | | |
| - | nr-DL-PRS-LOS-indicator | INTEGER(0,1) | OPTIONAL |
| - | Alt2: | | |
| - | nr-DL-PRS-LOS-confidence | INTEGER(0...100), | OPTIONAL |
| - | Alt3: | | |
| - | nr-DL-PRS-kFactor | INTEGER(0...K) | OPTIONAL |

-

| - | nr-AdditionalPathList-r16 | NR-AdditionalPathList-r16 |
|---|---|---|
| | OPTIONAL, | |
| - | nr-TimeStamp-r16 | NR-TimeStamp-r16, |
| - | nr-TimingQuality-r16 | NR-TimingQuality-r16, |
| - | nr-DL-PRS-RSRP-Result-r16 | INTEGER (0..126) |

| | |
|---|---|
| | OPTIONAL, |
| - | nr-Multi-RTT-AdditionalMeasurements-r16 |

| | |
|---|---|
| - | NR-Multi-RTT-AdditionalMeasurements-r16 |

| | |
|---|---|
| | OPTIONAL, |
| - | ... |
| - | } |

-

| - | NR-Multi-RTT-AdditionalMeasurements-r16 ::= SEQUENCE (SIZE (1..3)) OF | |
|---|---|---|
| - | | NR-Multi-RTT-AdditionalMeasurementElement-r16 |

-

| - | NR-Multi-RTT-AdditionalMeasurementElement-r16 ::= SEQUENCE { | | |
|---|---|---|---|
| - | nr-DL-PRS-ResourceID-r16 | NR-DL-PRS-ResourceID-r16 | |
| | OPTIONAL, | | |
| - | nr-DL-PRS-ResourceSetID-r16 | NR-DL-PRS-ResourceSetID-r16 | |
| | OPTIONAL, | | |
| - | nr-DL-PRS-RSRP-ResultDiff-r16 | INTEGER (0..61) | |
| | OPTIONAL, | | |
| - | nr-UE-RxTxTimeDiffAdditional-r16 | CHOICE { | |
| - | k0-r16 | INTEGER (0..8191), | |
| - | k1-r16 | INTEGER (0..4095), | |
| - | k2-r16 | INTEGER (0..2047), | |
| - | k3-r16 | INTEGER (0..1023), | |
| - | k4-r16 | INTEGER (0..511), | |
| - | k5-r16 | INTEGER (0..255), | |
| - | ... | | |
| - | }, | | |
| - | Alt1: | | |
| - | nr-DL-PRS-LOS-indicator | INTEGER(0,1) | OPTIONAL |
| - | Alt2: | | |
| - | nr-DL-PRS-LOS-confidence | INTEGER(0...100), | OPTIONAL |
| - | Alt3: | | |
| - | nr-DL-PRS-kFactor | INTEGER(0...K) | OPTIONAL |

| - | nr-Timing Quality-r16 | NR-TimingQuality-r16, |
|---|---|---|
| - | nr-AdditionalPathList-r16 | NR-AdditionalPathList-r16 |
| | OPTIONAL, | |
| - | nr-TimeStamp-r16 | NR-TimeStamp-r16, |

| | |
|---|---|
| - | ... |
| - | } |

At block 312, the location server (i.e., LMF) can request a positioning TRP (i.e., NG-RAN node) to report the NLOS/LOS measurement of positioning measurement. The location server can request one NG-RAN node to report the NLOS/LOS measurement for uplink angle of arrival measurement. The location server can request one NG-RAN node to report the NLOS/LOS measurement for uplink SRS-RSRP measurement. The location server can request one NG-RAN node to report the NLOS/LOS measurement for UL RTOA measurement. The location server can request one NG-RAN node to report the NLOS/LOS measurement for gNB Rx-Tx time difference measurement.

In one example, the LMF can request the NG-RAN node to report NLOS/LOS measurement of positioning measurement through the message MEASURE REQUEST, as following alternatives:

| IE/Group Name | Presence | Range | IE type and reference |
|---|---|---|---|
| Message Type | M | | 9.2.3 |
| NRPPa Transaction | M | | 9.2.4 |
| ID | | | |
| LMF Measurement | M | | INTEGER (1 . . . 65536, . . .) |
| ID | | | |
| TRP | | 1 | |
| Measurement | | | |
| Request List | | | |
| >TRP | | 1 . . . | |
| Measurement | | <maxnoofMeasTRPs> | |
| Request Item | | | |
| >>TRP ID | M | | 9.2.24 |
| >>Search | O | | 9.2.26 |
| Window | | | |
| Information | | | |
| >>Cell ID | O | | NR CGI |
| | | | 9.2.9 |
| Report | M | | ENUMERATED (OnDemand, |
| Characteristics | | | Periodic, . . .) |
| Measurement | C- | | ENUMERATED (120ms, 240ms, |
| Periodicity | ifReportCharac- | | 480ms, 640ms, 1024ms, 2048ms, |
| | teristicsPeriodic | | 5120ms, 10240ms, 1min, 6min, |
| | | | 12min, 30min, 60min, . . . , 20480ms, |
| | | | 40960ms) |
| TRP | | 1 | |
| Measurement | | | |
| Quantities | | | |
| >TRP | | 1 . . . | |
| Measurement | | <maxnoPosMeas> | |
| Quantities Item | | | |
| >TRP | M | | ENUMERATED (gNB- |
| Measurement | | | RxTxTimeDiff, UL-SRS-RSRP, |
| Type | | | UL-AoA, UL-RTOA, . . .) |
| >Timing | O | | INTEGER (0 . . . 5) |
| Reporting | | | |
| Granularity | | | |
| Factor | | | |
| Alt1: >Request | O | | |
| NLOS/LOS | | | |
| measurement | | | |
| report | | | |
| SFN initialisation | O | | 9.2.36 |
| Time | | | |
| SRS Configuration | O | | 9.2.28 |
| Measurement Beam | O | | ENUMERATED (true, . . .) |
| Information | | | |
| Request | | | |
| System Frame | O | | INTEGER(0 . . . 1023) |
| Number | | | |
| Slot Number | O | | INTEGER(0 . . . 79) |

| | |
|---|---|
| Alt2: Request | O |
| NLOS/LOS | |
| measurement report | |

As shown in the Alt1, the LMF can request NLOS/LOS measurement report for each requested TRP measurement Type. In Alt2, the LMF can request NLOS/LOS measurement report for all the requested TRP measurement type contained in the same MEASURE REQUEST message.

At block 315, the NG-RAN node can report NLOS/LOS measurement for one reported positioning measurement result that is reported to the location server. The NG-RAN node can report the NLOS/LOS measurement for uplink angle of arrival measurement. The NG-RAN node can report the NLOS/LOS measurement for uplink SRS-RSRP measurement. The NG-RAN node can report the NLOS/LOS measurement for UL RTOA measurement. The NG-RAN node can report the NLOS/LOS measurement for gNB Rx-Tx time difference measurement.

In one example, the NG-RAN node can report the NLOS/LOS measurement for positioning measurement in the information element TRP measurement Results, as shown in the Alt1, Alt2 or Alt3 as follows:

| | | | IE Type and |
|---|---|---|---|
| IE/Group Name | Presence | Range | Reference |
| Measured Result Item | | 1 . . . <maxnoPosMeas> | |
| >CHOICE Measured Results | M | | |
| Value | | | |
| >>UL Angle of Arrival | M | | 9.2.38 |
| >>UL SRS-RSRP | M | | INTEGER |
| | | | (0 . . . 126) |
| >>UL RTOA | M | | 9.2.39 |
| >>gNB Rx-Tx Time | M | | 9.2.40 |
| Difference | | | |
| >Time Stamp | M | | 9.2.42 |
| >Measurement Quality | O | | 9.2.43 |
| >Measurement Beam | O | | 9.2.57 |
| Information | | | |
| Alt1: | O | Alt1: INTEGER (0, 1) | |
| > NLOS/LOS indicator | | Alt2: INTEGER (0 . . . 100) | |
| Alt2: | | | |
| > LOS-confidence | | Alt3: | |
| | | INTEGER(0 . . . K) | |
| Alt3: | | | |
| >kFactor | | | |

In one example, the NG-RAN node can report the NLOS/LOS measurement for uplink angle of arrival measurement in the information element UL Angle of Arrival, as shown in the Alt1, Alt2 or Alt3 as follows:

| IE/Group Name | Presence | Range | IE Type and Reference |
|---|---|---|---|
| Azimuth Angle of | M | | INTEGER(0 . . . 3599) |
| Arrival | | | |
| Zenith Angle of | O | | INTEGER(0 . . . 1799) |
| Arrival | | | |
| Alt1: NLOS/LOS | O | Alt1: INTEGER (0, 1) | |
| indicator | | Alt2: INTEGER (0 . . . 100) | |
| Alt2: LOS-confidence | | Alt3: INTEGER(0 . . . K) | |
| Alt3: kFactor | | | |
| LCS to GCS | | 0 . . . 1 | |
| Translation | | | |
| >Alpha | M | | INTEGER (0 . . . 3599) |
| >Beta | M | | INTEGER (0 . . . 3599) |
| >Gamma | M | | INTEGER (0 . . . 3599) |

In one example, the NG-RAN node can report the NLOS/LOS measurement for uplink RTOA measurement in the information element UL RTOA Measurement, as shown in the Alt1, Alt2 or Alt3 as follows:

| IE/Group Name | Presence | Range | IE Type and Reference |
|---|---|---|---|
| CHOICE UL RTOA | M | | |
| Measurement | | | |
| >k0 | M | | INTEGER (0 . . . 1970049) |
| >k1 | M | | INTEGER (0 . . . 985025) |
| >k2 | M | | INTEGER (0 . . . 492513) |
| >k3 | M | | INTEGER (0 . . . 246257) |
| >k4 | M | | INTEGER (0 . . . 123129) |
| >k5 | M | | INTEGER (0 . . . 61565) |
| Alt1: NLOS/LOS | O | Alt1: INTEGER (0, 1) | |
| indicator | | Alt2: INTEGER (0 . . . 100) | |
| Alt2: LOS-confidence | | Alt3: INTEGER(0 . . . K) | |
| Alt3: kFactor | | | |
| Additional Path List | O | | 9.2.41 |

In one example, the NG-RAN node can report the NLOS/LOS measurement for gNB Rx-Tx time difference measurement in the information element gNB Rx-Tx Time Difference, as shown in the Alt1, Alt2 or Alt3 as follows:

| IE/Group Name | Presence | Range | IE Type and Reference |
|---|---|---|---|
| CHOICE gNB Rx-Tx | M | | |
| Time Difference | | | |
| Measurement | | | |
| >k0 | M | | INTEGER (0 . . . 1970049) |
| >k1 | M | | INTEGER (0 . . . 985025) |
| >k2 | M | | INTEGER (0 . . . 492513) |
| >k3 | M | | INTEGER (0 . . . 246257) |
| >k4 | M | | INTEGER (0 . . . 123129) |
| >k5 | M | | INTEGER (0 . . . 61565) |
| Alt1: NLOS/LOS | O | Alt1: INTEGER (0, 1) | |
| indicator | | Alt2: INTEGER (0 . . . 100) | |
| Alt2: LOS-confidence | | Alt3: INTEGER(0 . . . K) | |
| Alt3: kFactor | | | |
| Additional Path List | O | | 9.2.41 |

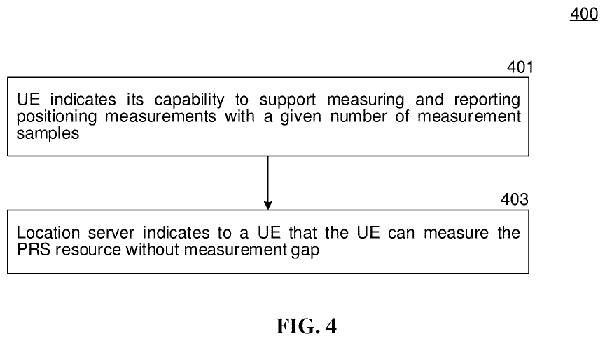

FIG. 4 is a flowchart of a method 400 for measuring downlink positioning reference signal in accordance with one or more implementations of the present disclosure. The method 400 can be implemented by a wireless communications system (e.g., the wireless communications system 100) that includes a terminal device (e.g., the terminal device 101) and a network node/device or gNB. The method 400 can support flexible positioning measurement with various number of samples and thus the system can choose the best balance between positioning measurement accuracy and latency. The method 400 can provide for the issue of measuring PRS resource to obtain corresponding positioning measurement results.

At block 401, a UE can indicate its capability to support measuring and reporting positioning measurements (for example DL RSTD measurement, PRS RSRP measurement, UE Rx-Tx time difference measurement) with a given number of measurement samples. Here the measurement sample can be a instance of PRS resource. The location server (e.g., LMF location management function) can configure the UE to report positioning measurement results that are obtained with a given number of measurement samples. According to the configuration provided by the location server, the UE can obtain the positioning measurement results with the given number of samples as configured by the location server and then reports one positioning measurement result and/or the number of measurement samples that is related with the reported positioning measurement results.

The location server can indicate one or more of the following to the UE on positioning measurement: the location server can indicate a number of measurement samples that the UE shall use to obtain the indicated positioning measurement result; The location server can indicate a minimum number of measurement samples that the UE shall use to obtain the indicated positioning measurement result; the location server can indicate a maximum number of measurement samples that the UE shall use to obtain the indicated positioning measurement result; or the location server can indicate a minimum number of measurement samples and a maximum number of measurement samples that the UE shall use to obtain the indicated positioning measurement result.

In one method, a UE can indicate its capability to support obtaining positioning measurement results with a given number of measurement samples. The UE can indicate a minimum number of measurement samples that the UE needs to obtain one positioning measurement result. The UE can indicate a maximum number of measurement samples that the UE needs to obtain one positioning measurement result. The UE can indicate the association between the measurement accuracy and the number of measurement samples that is used to obtain one positioning measurement results. The UE can report such UE capability for DL TDOA positioning method, for NR DL AoD and for NR Multi-RTT positioning.

In one example, the UE can indicate its capability to support RSTD measurement with a given number of measurement samples and provides its NR DL-TDOA positioning capabilities to the location server. In the UE capability report, the UE can report its capability to support RSTD measurement with a given number of measurement samples for the NR DL TDOA positioning. An example of the IE NR-DL-TDOA-ProvideCapabilities is given as follows:

| - | NR-DL-TDOA-ProvideCapabilities-r16 ::= SEQUENCE { | |
|---|---|---|
| - | nr-DL-TDOA-Mode-r16 | PositioningModes, |
| - | nr-DL-TDOA-PRS-Capability-r16 | NR-DL-PRS-ResourcesCapability-r16, |
| - | nr-DL-TDOA-MeasurementCapability-r16 NR-DL-TDOA-MeasurementCapability- | |
| | r16, | |
| - | nr-DL-PRS-QCL-ProcessingCapability-r16NR-DL-PRS-QCL-ProcessingCapability- | |
| | r16, | |
| - | nr-DL-PRS-ProcessingCapability-r16 | NR-DL-PRS-ProcessingCapability-r16, |
| - | additionalPathsReport-r16 | ENUMERATED { supported } |
| | OPTIONAL, | |
| - | periodicalReporting-r16 | PositioningModes |
| | OPTIONAL, | |
| - | numberofSamplesReporting | NR-DL-NumberOfSamples- |

| | |
|---|---|
| | ReportCapability OPTIONAL |
| - | ... |
| - | } |

In one example, the UE can indicate its capability to support PRS RSRP measurement with a given number of measurement samples and provides its NR DL-AoD positioning capabilities to the location server. In the UE capability report, the UE can report its capability to support PRS RSRP measurement with a given number of measurement samples for the NR DL-AoD positioning. An example of the IE NR-DL-AoD-ProvideCapabilities is given as follows:

| - | NR-DL-AoD-ProvideCapabilities-r16 ::= SEQUENCE { | |
|---|---|---|
| - | nr-DL-AoD-Mode-r16 | PositioningModes, |
| - | nr-DL-AoD-PRS-Capability-r16 | NR-DL-PRS-ResourcesCapability-r16, |
| - | nr-DL-AoD-MeasurementCapability-r16 | NR-DL-AoD-MeasurementCapability- |
| | r16, | |
| - | nr-DL-PRS-QCL-ProcessingCapability-r16NR-DL-PRS-QCL-ProcessingCapability- | |
| | r16, | |
| - | nr-DL-PRS-ProcessingCapability-r16 | NR-DL-PRS-ProcessingCapability-r16, |
| - | periodicalReporting-r16 | PositioningModes |
| | OPTIONAL, | |
| - | numberofSamplesReporting | NR-DL-NumberOfSamples- |

| | |
|---|---|
| | ReportCapability OPTIONAL |
| - | ... |
| - | } |

In one example, the UE can indicate its capability to support UE Rx-Tx time difference measurement with a given number of measurement samples and provides its NR multi-RTT positioning capabilities to the location server. In the UE capability report, the UE can report its capability to support UE Rx-Tx time difference measurement with a given number of measurement samples for the NR Multi-RTT positioning. An example of the IE NR-Multi-RTT-ProvideCapabilities is given as follows:

| - | NR-Multi-RTT-ProvideCapabilities-r16 ::= SEQUENCE { | |
|---|---|---|
| - | nr-Multi-RTT-PRS-Capability-r16 | NR-DL-PRS-ResourcesCapability-r16, |
| - | nr-Multi-RTT-MeasurementCapability-r16 NR-Multi-RTT-MeasurementCapability- | |
| | r16, | |
| - | nr-DL-PRS-QCL-ProcessingCapability-r16NR-DL-PRS-QCL-ProcessingCapability- | |
| | r16, | |
| - | nr-DL-PRS-ProcessingCapability-r16 | NR-DL-PRS-ProcessingCapability-r16, |
| - | nr-UL-SRS-Capability-r16 | NR-UL-SRS-Capability-r16, |
| - | additionalPathsReport-r16 | ENUMERATED { supported } |
| | OPTIONAL, | |
| - | periodicalReporting-r16 | ENUMERATED { supported } |
| | OPTIONAL, | |
| - | numberofSamplesReporting | NR-DL-NumberOfSamples- |

| | |
|---|---|
| | ReportCapability OPTIONAL |
| - | ... |
| - | } |

In a method, the location server can indicate the UE to obtain positioning measurement with a given number of measurement samples. Upon the indication from the location server, the UE can obtain each positioning measurement result with the indicated number of measurement samples and then report measurement results and/or the corresponding number of measurement samples used to obtain the measurement results to the location server.

In one example, the location server can configure the UE to calculate PRS RSRP for DL AoD location measurement with a given number of measurement samples through the assistance data for NR DL-AoD. The location server can provide that configuration in the IE NR-DL-AoD-ProvideAssistanceData:

| - | NR-DL-AoD-ProvideAssistanceData-r16 ::= SEQUENCE { | | |
|---|---|---|---|
| - | nr-DL-PRS-AssistanceData-r16 | NR-DL-PRS-AssistanceData-r16 | |
| | OPTIONAL, -- Need ON | | |
| - | nr-SelectedDL-PRS-IndexList-r16 | NR-SelectedDL-PRS-IndexList-r16 | |
| | OPTIONAL, -- Need ON | | |
| - | nr-PositionCalculationAssistance-r16 | | |
| - | | NR-PositionCalculationAssistance-r16 | |
| - | | | OPTIONAL, - |

| | - Cond UEB | |
|---|---|---|
| - | nr-DL-AoD-Error-r16 | NR-DL-AoD-Error-r16 |

| | OPTIONAL, -- Need ON | |
|---|---|---|
| - | Alt1: nr-Number-Samples-RSRPMeasurement INTEGER | OPTIONAL |

| | |
|---|---|
| - | Alt2: nr-minNumber-Samples-RSRPMeasurement INTEGER |
| | OPTIONAL, |
| - | Alt3: nr-maxNumber-Samples-RSRPMeasurement INTEGER |
| | OPTIONAL |
| - | ... |
| - | } |

Where:
Alt1: the field nr-Number-Samples-RSRPMeasurement is used to specify the number of measurement samples that the UE shall use to obtain on PRS RSRP measurement.
Alt2: the field nr-minNumber-Samples-RSRPMeasurement is used to specify the minimum number of measurement samples that the UE shall use to obtain on PRS RSRP measurement.
Alt3: the field nr-maxNumber-Samples-RSRPMeasurement is used to specify the maximum number of measurement samples that the UE shall use to obtain on PRS RSRP measurement.

Note one or more of the Alt1, Alt2 and Alt3 can be included.

In one example, the location server can configure the UE to calculate PRS RSRP for DL AoD location measurement with a given number of measurement samples through the IE NR-DL-AoD-RequestLocationInformation:

| - | NR-DL-AoD-RequestLocationInformation-r16 ::= SEQUENCE { | |
|---|---|---|
| - | nr-AssistanceAvailability-r16 | BOOLEAN, |
| - | nr-DL-AoD-ReportConfig-r16 | NR-DL-AoD-ReportConfig-r16, |
| - | Alt1: nr-Number-Samples-RSRPMeasurement INTEGER | OPTIONAL |

| | |
|---|---|
| - | Alt2: nr-minNumber-Samples-RSRPMeasurement INTEGER |
| | OPTIONAL, |
| - | Alt3: nr-maxNumber-Samples-RSRPMeasurement INTEGER |
| | OPTIONAL |
| - | ... |
| - | } |

In another example, the location server can configure the UE to calculate PRS RSRP for DL AoD location measurement with a given number of measurement samples through the IE NR-DL-AoD-ReportConfig:

NR-DL-AoD-ReportConfig-r16 ::= SEQUENCE {

| | maxDL-PRS-RSRP-MeasurementsPerTRP-r16 | INTEGER (1..8) |
|---|---|---|
| | OPTIONAL, | |
| - | Alt1: nr-Number-Samples-RSRPMeasurement | OPTIONAL |
| | INTEGER | |

| | |
|---|---|
| - | Alt2: nr-minNumber-Samples-RSRPMeasurement INTEGER |

OPTIONAL,

| | |
|---|---|
| - | Alt3: nr-maxNumber-Samples-RSRPMeasurement INTEGER |

OPTIONAL

...

}

In one example, a UE can report the number of measurement samples used for a NR AoD measurements to the location server. For example, the UE can report the number of measurement samples used to obtain one AoD measurement in IE NR-DL-AoD-SignalMeasurementInformation as follows:

| - | NR-DL-AoD-SignalMeasurementInformation-r16 ::= SEQUENCE { | |
|---|---|---|
| - | nr-DL-AoD-MeasList-r16 | NR-DL-AoD-MeasList-r16, |

| | |
|---|---|
| - | ... |
| - | } |

-

| | |
|---|---|
| - | NR-DL-AoD-MeasList-r16 ::= SEQUENCE (SIZE(1..nrMaxTRPs-r16)) OF NR- |
| | DL-AoD-MeasElement-r16 |

-

| - | NR-DL-AoD-MeasElement-r16 ::= SEQUENCE { | |
|---|---|---|
| - | dl-PRS-ID-r16 | INTEGER (0..255), |
| - | nr-PhysCellID-r16 | NR-PhysCellID-r16 |
| | OPTIONAL, | |
| - | nr-CellGlobalID-r16 | NCGI-r15 |
| | OPTIONAL, | |
| - | nr-ARFCN-r16 | ARFCN-ValueNR-r15 |
| | OPTIONAL, | |
| - | nr-DL-PRS-ResourceID-r16 | NR-DL-PRS-ResourceID-r16 |
| | OPTIONAL, | |
| - | nr-DL-PRS-ResourceSetID-r16 | NR-DL-PRS-ResourceSetID-r16 |
| | OPTIONAL, | |
| - | nr-TimeStamp-r16 | NR-TimeStamp-r16, |
| - | nr-DL-PRS-RSRP-Result-r16 | INTEGER (0..126), |
| - | nr-DL-PRS-RxBeamIndex-r16 | INTEGER (1..8) |

OPTIONAL, -- Cond SameRx

| | | |
|---|---|---|
| nr-number-Samples | INTEGER(1...K) | OPTIONAL |

| - | nr-DL-AoD-AdditionalMeasurements-r16 | |
|---|---|---|
| - | | NR-DL-AoD-AdditionalMeasurements-r16 |

| | |
|---|---|
| | OPTIONAL, |
| - | ... |
| - | } |

-

| - | NR-DL-AoD-AdditionalMeasurements-r16 ::= SEQUENCE (SIZE (1..7)) OF | |
|---|---|---|
| - | | NR-DL-AoD- |

AdditionalMeasurementElement-r16

-

| - | NR-DL-AoD-AdditionalMeasurementElement-r16 ::= SEQUENCE { | | |
|---|---|---|---|
| - | nr-DL-PRS-ResourceID-r16 | NR-DL-PRS-ResourceID-r16 | |
| | OPTIONAL, | | |
| - | nr-DL-PRS-ResourceSetID-r16 | NR-DL-PRS-ResourceSetID-r16 | |
| | OPTIONAL, | | |
| - | nr-TimeStamp-r16 | NR-TimeStamp-r16, | |
| - | nr-DL-PRS-RSRP-ResultDiff-r16 | INTEGER (0..30), | |
| - | nr-DL-PRS-RxBeamIndex-r16 | INTEGER (1..8) | |
| | OPTIONAL, -- Cond SameRx | | |
| - | nr-number-Samples | INTEGER(1...K) | OPTIONAL |

-

| | |
|---|---|
| - | ... |
| - | } |

In one example, the location server can configure the UE to obtain DL-TDOA location measurement with a given number of measurement samples through the assistance data for NR DL-DTOA. The location server can provide that configuration in the IE NR-DL-TDOA-ProvideAssistanceData as follows:

| - | NR-DL-TDOA-ProvideAssistanceData-r16 ::= SEQUENCE { | |
|---|---|---|
| - | nr-DL-PRS-AssistanceData-r16 | NR-DL-PRS-AssistanceData-r16 |
| | OPTIONAL, -- Need ON | |
| - | nr-SelectedDL-PRS-IndexList-r16 | NR-SelectedDL-PRS-IndexList-r16 |
| | OPTIONAL, -- Need ON | |
| - | nr-PositionCalculationAssistance-r16 | |
| - | | NR-PositionCalculationAssistance-r16 |
| - | | OPTIONAL, -- Cond UEB |
| - | nr-DL-TDOA-Error-r16 | NR-DL-TDOA-Error-r16 |
| | OPTIONAL, -- Need ON | |
| - | Alt1: nr-Number-Samples-RSTDMeasurement INTEGER | OPTIONAL |

| | |
|---|---|
| - | Alt2: nr-minNumber-Samples-RSTDMeasurement INTEGER |
| | OPTIONAL, |
| - | Alt3: nr-maxNumber-Samples-RSTDMeasurement INTEGER |
| | OPTIONAL |
| - | ... |
| - | } |

Where:
Alt1: the field nr-Number-Samples-RSTDMeasurement is used to specify the number of measurement samples that the UE shall use to obtain on RSTD measurement.
Alt2: the field nr-minNumber-Samples-RSTDMeasurement is used to specify the minimum number of measurement samples that the UE shall use to obtain on RSTD measurement.
Alt3: the field nr-maxNumber-Samples-RSTDMeasurement is used to specify the maximum number of measurement samples that the UE shall use to obtain on RSTD measurement.

Note one or more of the Alt1, Alt2 and Alt3 can be included.

In one example, the location server can request the UE to obtain the DL-TDOA measurement with a given number of measurement samples through the IE NR-DL-TDOA-RequestLocationInformation as follows:

| - | NR-DL-TDOA-RequestLocationInformation-r16 ::= SEQUENCE { | |
|---|---|---|
| - | nr-DL-PRS-RstdMeasurementInfoRequest-r16 ENUMERATED { true } | |
| | OPTIONAL,-- Need ON | |
| - | nr-RequestedMeasurements-r16 | BIT STRING { prsrsrpReq (0) } |
| | (SIZE(1..8)), | |
| - | nr-AssistanceAvailability-r16 | BOOLEAN, |
| - | nr-DL-TDOA-ReportConfig-r16 | NR-DL-TDOA-ReportConfig-r16 |
| | OPTIONAL, -- Need ON | |
| - | additionalPaths-r16 | ENUMERATED { requested } |
| | OPTIONAL, -- Need ON | |
| - | Alt1: nr-Number-Samples-RSTDMeasurement INTEGER | OPTIONAL |

| | |
|---|---|
| - | Alt2: nr-minNumber-Samples-RSTDMeasurement INTEGER |
| | OPTIONAL, |
| - | Alt3: nr-maxNumber-Samples-RSTDMeasurement INTEGER |
| | OPTIONAL |
| - | ... |

In another example, the location server can request the UE to obtain DL-TDOA measurement with a given number of measurement samples through the IE NR-DL-TDOA-ReportConfig as follows:

| - | NR-DL-TDOA-ReportConfig-r16 ::= SEQUENCE { | |
|---|---|---|
| - | maxDL-PRS-RSTD-MeasurementsPerTRPPair-r16 INTEGER (1..4) | |
| | OPTIONAL, -- Need ON | |
| - | timingReportingGranularityFactor-r16 | INTEGER (0..5) |
| | OPTIONAL, -- Need ON | |
| - | Alt1: nr-Number-Samples-RSTDMeasurement | OPTIONAL |
| | INTEGER | |

| | |
|---|---|
| - | Alt2: nr-minNumber-Samples-RSTDMeasurement INTEGER |
| | OPTIONAL, |
| - | Alt3: nr-maxNumber-Samples-RSTDMeasurement INTEGER |
| | OPTIONAL |
| - | ... |
| - | } |

In one example, a UE can report the number of measurement samples used to obtain each NR DL-TDOA measurements to the location server. For example, the UE can report the number of measurement samples used to obtain a DL-DTOA measurement (i.e., RSTD measurement) in IE NR-DL-TDOA-SignalMeasurementInformation as follows:

| - | NR-DL-TDOA-SignalMeasurementInformation-r16 ::= SEQUENCE { | | |
|---|---|---|---|
| - | dl-PRS-ReferenceInfo-r16 | DL-PRS-ID-Info-r16, | |
| - | nr-number-Samples | INTEGER(1...K) | OPTIONAL |

| | | |
|---|---|---|
| - | nr-DL-TDOA-MeasList-r16 | NR-DL-TDOA-MeasList-r16, |

| | |
|---|---|
| - | ... |
| - | } |

-

| | |
|---|---|
| - | NR-DL-TDOA-MeasList-r16 ::= SEQUENCE (SIZE(1..nrMaxTRPs-r16)) OF NR- |
| | DL-TDOA-MeasElement-r16 |

-

| - | NR-DL-TDOA-MeasElement-r16 ::= SEQUENCE { | | |
|---|---|---|---|
| - | dl-PRS-ID-r16 | INTEGER (0..255), | |
| - | nr-PhysCellID-r16 | NR-PhysCellID-r16 | |
| | OPTIONAL, | | |
| - | nr-CellGlobalID-r16 | NCGI-r15 | |
| | OPTIONAL, | | |
| - | nr-ARFCN-r16 | ARFCN-ValueNR-r15 | |
| | OPTIONAL, | | |
| - | nr-DL-PRS-ResourceID-r16 | NR-DL-PRS-ResourceID-r16 | |
| | OPTIONAL, | | |
| - | nr-DL-PRS-ResourceSetID-r16 | NR-DL-PRS-ResourceSetID-r16 | |
| | OPTIONAL, | | |
| - | nr-TimeStamp-r16 | NR-TimeStamp-r16, | |
| - | nr-RSTD-r16 | CHOICE { | |
| - | k0-r16 | INTEGER (0..1970049), | |
| - | k1-r16 | INTEGER (0..985025), | |
| - | k2-r16 | INTEGER (0..492513), | |
| - | k3-r16 | INTEGER (0..246257), | |
| - | k4-r16 | INTEGER (0..123129), | |
| - | k5-r16 | INTEGER (0..61565), | |
| - | ... | | |
| - | }, | | |
| - | nr-number-Samples | INTEGER(1...K) | OPTIONAL |

| - | nr-AdditionalPathList-r16 | NR-AdditionalPathList-r16 |
|---|---|---|
| | OPTIONAL, | |
| - | nr-TimingQuality-r16 | NR-TimingQuality-r16, |
| - | nr-DL-PRS-RSRP-Result-r16 | INTEGER (0..126) |
| | OPTIONAL, | |
| - | nr-DL-TDOA-AdditionalMeasurements-r16 | |
| - | | NR-DL-TDOA-AdditionalMeasurements-r16 |

| | |
|---|---|
| | OPTIONAL, |
| - | ... |
| - | } |

-

| - | NR-DL-TDOA-AdditionalMeasurements-r16 ::= SEQUENCE (SIZE (1..3)) OF | |
|---|---|---|
| - | | NR-DL-TDOA- |

AdditionalMeasurementElement-r16

-

| - | NR-DL-TDOA-AdditionalMeasurementElement-r16 ::= SEQUENCE { | | |
|---|---|---|---|
| - | nr-DL-PRS-ResourceID-r16 | NR-DL-PRS-ResourceID-r16 | |
| | OPTIONAL, | | |
| - | nr-DL-PRS-ResourceSetID-r16 | NR-DL-PRS-ResourceSetID-r16 | |
| | OPTIONAL, | | |
| - | nr-TimeStamp-r16 | NR-TimeStamp-r16, | |
| - | nr-RSTD-ResultDiff-r16 | CHOICE { | |
| - | k0-r16 | INTEGER (0..8191), | |
| - | k1-r16 | INTEGER (0..4095), | |
| - | k2-r16 | INTEGER (0..2047), | |
| - | k3-r16 | INTEGER (0..1023), | |
| - | k4-r16 | INTEGER (0..511), | |
| - | k5-r16 | INTEGER (0..255), | |
| - | ... | | |
| - | }, | | |
| - | nr-number-Samples | INTEGER(1...K) | OPTIONAL |

| - | nr-Timing Quality-r16 | NR-TimingQuality-r16, |
|---|---|---|
| - | nr-DL-PRS-RSRP-ResultDiff-r16 | INTEGER (0..61) |
| | OPTIONAL, | |
| - | nr-AdditionalPathList-r16 | NR-AdditionalPathList-r16 |

| | |
|---|---|
| | OPTIONAL, |
| - | ... |
| - | } |

In one example, the location server can configure the UE to obtain a NR multi-RTT location measurement with a given number of measurement samples through the assistance data for NR multi-RTT. The location server can provide that configuration in the IE NR-Multi-RTT-ProvideAssistanceData as follows:

| - | NR-Multi-RTT-ProvideAssistanceData-r16 ::= SEQUENCE { | |
|---|---|---|
| - | nr-DL-PRS-AssistanceData-r16 | NR-DL-PRS-AssistanceData-r16 |
| | OPTIONAL, -- Need ON | |
| - | nr-SelectedDL-PRS-IndexList-r16 | NR-SelectedDL-PRS-IndexList-r16 |
| | OPTIONAL, -- Need ON | |
| - | nr-Multi-RTT-Error-r16 | NR-Multi-RTT-Error-r16 |

| | |
|---|---|
| | OPTIONAL, -- Need ON |
| - | Alt1: nr-Number-Samples-Multi-RTT-Measurement INTEGER |
| | OPTIONAL |
| - | Alt2: nr-minNumber-Samples-Multi-RTT-Measurement INTEGER |
| | OPTIONAL, |
| - | Alt3: nr-maxNumber-Samples-Multi-RTT-Measurement INTEGER |
| | OPTIONAL |

-

| | |
|---|---|
| - | ... |
| - | } |

In one example, the location server can request the UE to obtain NR multi-RTT measurement with a given number of measurement samples through the IE NR-Multi-RTT-RequestLocationInformation as follows:

| - | NR-Multi-RTT-RequestLocationInformation-r16 ::= SEQUENCE { | |
|---|---|---|
| - | nr-UE-RxTxTimeDiffMeasurementInfoRequest-r16 | |
| - | | ENUMERATED { true } |
| | OPTIONAL, -- Need ON | |
| - | nr-RequestedMeasurements-r16 | BIT STRING { prsrsrpReq(0)} (SIZE(1..8)), |
| - | nr-AssistanceAvailability-r16 | BOOLEAN, |
| - | nr-Multi-RTT-ReportConfig-r16 | NR-Multi-RTT-ReportConfig-r16, |
| - | additionalPaths-r16 | ENUMERATED { requested } |

| | |
|---|---|
| | OPTIONAL, -- Need ON |
| - | Alt1: nr-Number-Samples-Multi-RTT-Measurement INTEGER |
| | OPTIONAL |
| | Alt2: nr-minNumber-Samples-Multi-RTT-Measurement INTEGER |
| | OPTIONAL, |
| - | Alt3: nr-maxNumber-Samples-Multi-RTT-Measurement INTEGER |
| | OPTIONAL |
| - | ... |
| - | } |

In another example, the location server can request the UE to obtain a NR multi-RTT measurement with a given number of measurement samples through the IE NR-Multi-RTT-ReportConfig as follows:

NR-Multi-RTT-ReportConfig-r16 ::= SEQUENCE {

| | |
|---|---|
| maxDL-PRS-RxTxTimeDiffMeasPerTRP-r16 | INTEGER (1..4) |

OPTIONAL, -- Need ON

| | | |
|---|---|---|
| timingReportingGranularityFactor-r16 | INTEGER (0..5) | OPTIONAL-- |

Need ON
- Alt1: nr-Number-Samples-Multi-RTT-Measurement INTEGER
OPTIONAL
- Alt2: nr-minNumber-Samples-Multi-RTT-Measurement INTEGER
OPTIONAL,
- Alt3: nr-maxNumber-Samples-Multi-RTT-Measurement INTEGER
OPTIONAL
}

In one example, a UE can report the number of measurement samples that is used to obtain a NR multi-RTT measurements to the location server. For example, the UE can report the number of measurement samples used to obtain each multi-RTT measurement in IE NR-Multi-RTT-SignalMeasurementInformation as follows:

| - | NR-Multi-RTT-SignalMeasurementInformation-r16 ::= SEQUENCE { | |
|---|---|---|
| - | nr-Multi-RTT-MeasList-r16 | NR-Multi-RTT-MeasList-r16, |
| - | nr-NTA-Offset-r16 | ENUMERATED { nTA1, nTA2, nTA3, nTA4, ... } |

| | |
|---|---|
| | OPTIONAL, |
| - | ... |
| - | } |

-

| - | NR-Multi-RTT-MeasList-r16 ::= SEQUENCE (SIZE(1..nrMaxTRPs-r16)) OF NR- | | |
|---|---|---|---|
| | Multi-RTT-MeasElement-r16 | | |
| - | NR-Multi-RTT-MeasElement-r16 ::= SEQUENCE { | | |
| - | dl-PRS-ID-r16 | INTEGER (0..255), | |
| - | nr-PhysCellID-r16 | NR-PhysCellID-r16 | |
| | OPTIONAL, | | |
| - | nr-CellGlobalID-r16 | NCGI-r15 | |
| | OPTIONAL, | | |
| - | nr-ARFCN-r16 | ARFCN-ValueNR-r15 | |
| | OPTIONAL, | | |
| - | nr-DL-PRS-ResourceID-r16 | NR-DL-PRS-ResourceID-r16 | |
| | OPTIONAL, | | |
| - | nr-DL-PRS-ResourceSetID-r16 | NR-DL-PRS-ResourceSetID-r16 | |
| | OPTIONAL, | | |
| - | nr-UE-RxTxTimeDiff-r16 | CHOICE { | |
| - | k0-r16 | INTEGER (0..1970049), | |
| - | k1-r16 | INTEGER (0..985025), | |
| - | k2-r16 | INTEGER (0..492513), | |
| - | k3-r16 | INTEGER (0..246257), | |
| - | k4-r16 | INTEGER (0..123129), | |
| - | k5-r16 | INTEGER (0..61565), | |
| - | ... | | |
| - | }, | | |
| - | nr-number-Samples | INTEGER(1...K) | OPTIONAL |

-

| - | nr-AdditionalPathList-r16 | NR-AdditionalPathList-r16 |
|---|---|---|
| | OPTIONAL, | |
| - | nr-TimeStamp-r16 | NR-TimeStamp-r16, |
| - | nr-Timing Quality-r16 | NR-TimingQuality-r16, |
| - | nr-DL-PRS-RSRP-Result-r16 | INTEGER (0..126) |
| | OPTIONAL, | |
| - | nr-Multi-RTT-AdditionalMeasurements-r16 | |
| - | | NR-Multi-RTT-AdditionalMeasurements-r16 |
| | OPTIONAL, | |
| - | ... | |
| - | } | |
| - | | |
| - | NR-Multi-RTT-AdditionalMeasurements-r16 ::= SEQUENCE (SIZE (1..3)) OF | |
| - | | NR-Multi-RTT-AdditionalMeasurementElement- |

r16

-

| - | NR-Multi-RTT-AdditionalMeasurementElement-r16 ::= SEQUENCE { | | |
|---|---|---|---|
| - | nr-DL-PRS-ResourceID-r16 | NR-DL-PRS-ResourceID-r16 | |
| | OPTIONAL, | | |
| - | nr-DL-PRS-ResourceSetID-r16 | NR-DL-PRS-ResourceSetID-r16 | |
| | OPTIONAL, | | |
| - | nr-DL-PRS-RSRP-ResultDiff-r16 | INTEGER (0..61) | |
| | OPTIONAL, | | |
| - | nr-UE-RxTxTimeDiffAdditional-r16 | CHOICE { | |
| - | k0-r16 | INTEGER (0..8191), | |
| - | k1-r16 | INTEGER (0..4095), | |
| - | k2-r16 | INTEGER (0..2047), | |
| - | k3-r16 | INTEGER (0..1023), | |
| - | k4-r16 | INTEGER (0..511), | |
| - | k5-r16 | INTEGER (0..255), | |
| - | ... | | |
| - | }, | | |
| - | nr-number-Samples | INTEGER(1...K) | OPTIONAL |

| - | nr-TimingQuality-r16 | NR-TimingQuality-r16, |
|---|---|---|
| - | nr-AdditionalPathList-r16 | NR-AdditionalPathList-r16 |
| | OPTIONAL, | |
| - | nr-TimeStamp-r16 | NR-TimeStamp-r16, |

| | |
|---|---|
| - | ... |
| - | } |

At block 403, the location server can indicate a UE that the UE can measure the PRS resource without measurement gap. The location server can indicate the UE on processing PRS resource according to one or more of the following examples: the location server can indicate the UE that the UE can measure all the PRS resources without measurement gap; the location server can indicate the UE that the UE can measure all the PRS resources from one particular TRP without measurement gap; the location server can indicate the UE that the UE can measure all the PRS resources contained in one particular PRS resource set without measurement gap; the location server can indicate the UE that the UE can measure all the PRS resources configured in one particular frequency layer without measurement gap; and/or the location server can indicate the UE that the UE can measure one particular PRS resource without measurement gap.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the disclosure is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the disclosure are presented below in certain claim forms, the applicant contemplates the various aspects of the disclosure in any number of claim forms. Accordingly, the applicant reserves the right to pursue additional claims after filing this application to pursue such additional claim forms, in either this application or in a continuing application.

1. A method for positioning measurement reporting comprising:
sending, from a terminal device, a first message indicating a capability to support reporting information of line of sight (LOS) or non-line of sight (NLOS) of a path used in positioning measurement; and
reporting, by the terminal device, at least one positioning measurement result and the information of the LOS or NLOS of the path corresponding to the at least one positioning measurement result.

2. The method of claim 1, further comprising:
receiving, at the terminal device, a request for the terminal device to calculate an LOS or NLOS measurement for at least one downlink angle of departure (AoD) location measurement;
calculating, by the terminal device, the LOS or NLOS measurement for the at least one downlink AoD location measurement; and
reporting, by the terminal device, the LOS or NLOS measurement for the calculated at least one downlink AoD location measurement.

3. The method of claim 1, further comprising:
receiving, at the terminal device, a request for the terminal device to calculate an LOS or NLOS measurement for at least one downlink time difference of arrival (TDOA) location measurement;
calculating, by the terminal device, the LOS or NLOS measurement for the at least one downlink TDOA location measurement; and
reporting, by the terminal device, the LOS or NLOS measurement for the calculated at least one downlink TDOA location measurement.

4. The method of claim 1, further comprising:
receiving, at the terminal device, a request for the terminal device to calculate an LOS or NLOS measurement for at least one NR multi-round trip time (RTT) location measurement; and
calculating, by the terminal device, the LOS or NLOS measurement for the at least one NR multi-RTT location measurement; and
reporting, by the terminal device, the LOS or NLOS measurement for the calculated at least one NR multi-RTT location measurement.

5. The method of claim 1, further comprising:
sending, from the terminal device, a second message indicating a capability to support measuring and reporting positioning measurements with a given number of measurement samples.

6. The method of claim 5, wherein the positioning measurements include at least a downlink reference signal time difference (RSTD) measurement, a PRS reference signal received power (RSRP) measurement, or an Rx-Tx time difference measurement.

7. The method of claim 1, further comprising:
receiving, by the terminal device, a third message that the terminal device has a capability to measure a PRS resource without measurement gap.

8. The method of claim 1, wherein a positioning transmission-reception point (TRP) receives a request to report an NLOS or LOS measurement of positioning measurement.

9. The method of claim 1, wherein a TRP reports an NLOS or LOS measurement for at least one reported positioning measurement result.

10. An apparatus, comprising:
a memory; and
a processor coupled to the memory and configured to perform a process comprising:
sending, from a terminal device, a first message indicating a capability to support reporting information of line of sight (LOS) or non-line of sight (NLOS) of a path used in positioning measurement; and
reporting, by the terminal device, at least one positioning measurement result and the information of the LOS or NLOS of the path corresponding to the at least one positioning measurement result.

11. The apparatus of claim 10, wherein the process further comprises:
receiving, at the terminal device, a request for the terminal device to calculate an LOS or NLOS measurement for at least one downlink angle of departure (AoD) location measurement;
calculating, by the terminal device, the LOS or NLOS measurement for the at least one downlink AoD location measurement; and
reporting, by the terminal device, the LOS or NLOS measurement for the calculated at least one downlink AoD location measurement.

12. The apparatus of claim 10, wherein the process further comprises:
receiving, at the terminal device, a request for the terminal device to calculate an LOS or NLOS measurement for at least one downlink time difference of arrival (TDOA) location measurement;
calculating, by the terminal device, the LOS or NLOS measurement for the at least one downlink TDOA location measurement; and
reporting, by the terminal device, the LOS or NLOS measurement for the calculated at least one downlink TDOA location measurement.

13. The apparatus of claim 10, wherein the process further comprises:
receiving, at the terminal device, a request for the terminal device to calculate an LOS or NLOS measurement for at least one NR multi-round trip time (RTT) location measurement; and
calculating, by the terminal device, the LOS or NLOS measurement for the at least one NR multi-RTT location measurement; and
reporting, by the terminal device, the LOS or NLOS measurement for the calculated at least one NR multi-RTT location measurement.

14. The apparatus of claim 10, wherein the process further comprises:
sending, from the terminal device, a second message indicating a capability to support measuring and reporting positioning measurements with a given number of measurement samples.

15. A system, comprising:
a terminal device configured to perform a process comprising:
sending, from the terminal device, a first message indicating a capability to support reporting information of line of sight (LOS) or non-line of sight (NLOS) of a path used in positioning measurement; and
reporting, by the terminal device, at least one positioning measurement result and the information of the LOS or NLOS of the path corresponding to the at least one positioning measurement result.

16. The system of claim 15, wherein the process further comprises:
receiving, at the terminal device, a request for the terminal device to calculate an LOS or NLOS measurement for at least one downlink angle of departure (AoD) location measurement;
calculating, by the terminal device, the LOS or NLOS measurement for the at least one downlink AoD location measurement; and
reporting, by the terminal device, the LOS or NLOS measurement for the calculated at least one downlink AoD location measurement.

17. The system of claim 15, wherein the process further comprises:
receiving, at the terminal device, a request for the terminal device to calculate an LOS or NLOS measurement for at least one downlink time difference of arrival (TDOA) location measurement;
calculating, by the terminal device, the LOS or NLOS measurement for the at least one downlink TDOA location measurement; and
reporting, by the terminal device, the LOS or NLOS measurement for the calculated at least one downlink TDOA location measurement.

18. The system of claim 15, wherein the process further comprises:
receiving, at the terminal device, a request for the terminal device to calculate an LOS or NLOS measurement for at least one NR multi-round trip time (RTT) location measurement; and
calculating, by the terminal device, the LOS or NLOS measurement for the at least one NR multi-RTT location measurement; and
reporting, by the terminal device, the LOS or NLOS measurement for the calculated at least one NR multi-RTT location measurement.

19. The system of claim 15, wherein the process further comprises:
sending, from the terminal device, a second message indicating a capability to support measuring and reporting positioning measurements with a given number of measurement samples.

20. The system of claim 15, wherein the process further comprises:
receiving a third message that the terminal device has a capability to measure a PRS resource without measurement gap.
